(19) United States
(12) Patent Application Publication
(10) Pub. No.: US 2003/0166988 A1
(43) Pub. Date: Sep. 4, 2003

(54) Method for inhibiting the formation of dioxins

(76) Inventors: Christopher A. Hazen, Leverkusen (DE); James I. Myers, Loudon, TN (US); Anand Srinivasan, Pittsburgh, PA (US); Bernhard Wilhelm Vosteen, Koeln (DE)

Correspondence Address: BAYER POLYMERS LLC, 100 BAYER ROAD, PITTSBURGH, PA, 15205, US

(21) Appl. No.: 09/808,485

(22) Filed: Mar. 14, 2001

(51) Int. Cl. A62D 3/00

(52) U.S. Cl. 588/209

(57) ABSTRACT

A method for reducing dioxin levels from a sludge disposal process comprising: (a) adding a halogenation supressant to a composition containing dioxin precursors, (b) incinerating the composition containing dioxin precursors, thereby forming a gaseous medium, (c) reducing heat in the gaseous medium formed in step (b), (d) removing ash from the gaseous medium, (e) adding an adsorbent to the gaseous medium formed in step (d), and (f) removing acid gases and particulates from the gaseous medium formed in step (e).

### BACKGROUND

Environmental pollution of dioxins, produced when industrial and other wastes are burned, has become one of the most pressing societal problems in recent years. Dioxin is a general term for virulently poisonous isomers having a molecular structure consisting of two benzene rings bonded together by two oxygen atoms, and halogen atoms bonded to the benzene rings. Dioxins may be produced in large amounts especially when any waste containing chlorine are burned. Dioxins not only pollute the atmosphere, but also the soil and water by falling onto the ground. Waste ashes are also a leading cause of soil pollution because they also contain a large amount of dioxin.

Recent governmental regulations for hazardous waste incinerators stipulate, among other things, stringent emission standards for polychlorinated dibenzo-p-dioxins and polychlorinated dibenzofurans. These standards require existing hazardous waste incinerators to control polychlorinated dibenzo-p-dioxins and polychlorinated dibenzofurans emissions to very low levels. Accordingly, it would be desired to develop a process that reduces the formation of polychlorinated dibenzo-p-dioxins and polychlorinated dibenzofurans.

Previous efforts that have addressed the subject of dioxin formation have been unsuccessful at developing an affordable, effective process to reduce polychlorinated dibenzo-p-dioxins and polychlorinated dibenzofurans at an industrial scale. Griffin, “A New Theory of Dioxin Formation in Municipal Solid Waste Combustion” Chemosphere, Vol.15, pp.1987-1990 (1986), proposes a theory of polychlorinated dioxin from Municipal Solid Waste and coal combustion. The paper concludes that chlorine gas is a key intermediary in the formation of chlorinated dioxin compounds. The paper also concludes that in combustion (coal combustion), the role of sulfur dioxide in inter-fering with the chlorination step (and hence the formation of polychlor-inated dioxin) is critical. According to the paper, when sulfur dioxide is present in excess over chlorine, in any system, the following competing reaction SO₂+Cl₂+H₂O→SO₃+2HCl predominates, and indicates that Cl₂ would not be present in sufficient quantities and the formation of chlorinated aromatics will not occur.

Volthardt, “Measures for Reduction in the De-Novo Formation of Dioxins/Furans in Special Refuse Incineration Plants” Chem-lng.-Tech. 63 (1991) Nt. 6. pp. 621-622 discusses the formation of dioxins/furans in refuse and incineration plants. The paper teaches that the following factors are favorable in the formation mechanism of dioxins/furans: (i) gas temperatures from 450 to 250° C., high delay times, high chlorine content in waste gas, free carbon or hydrocarbon compounds, and deposition of fly ash. The paper teaches, among other things, that procedures that utilize temperatures below 200° C. are disadvantageous because of problems such as costs, residual material, and uncertainty of the procedure.

Kazunori et al., “Development of Dioxins Removal Systems for EAF” Denkl Delko (1999) 70(2) pp.127-132 is a study of two types of removal systems for dioxins for flue gas from a steelmaking electric arc furnace (EAF). One of the systems consists of double bag houses and another system has an activated carbon injection system besides the double bag houses.

U.S. Pat. No. 5,288,299 is directed to a bag filter that has a filter cloth and a retainer that supports the filter cloth so that, exhaust gas is passed through a bag filter. An activated carbon-containing sorbent layer for adsorbing dioxin is installed along the filter cloth of the bag filter at the exhaust gas outlet side of the bag filter.

Unfortunately, such efforts have not provided useful guidelines that would be helpful in developing an affordable, effective process to reduce dioxins at an industrial scale.

### SUMMARY

The invention relates to a method that reduces dioxin levels from a process that produces dioxins. The method comprises (a) adding sulfur, or another halogenation suppressant, or mixtures thereof to a composition containing dioxin precursors, (b) incinerating the composition that contains the dioxin precursors, thereby forming a gaseous medium, (c) reducing heat in the gaseous medium formed in step (b), (d) removing ash from the gaseous medium, (e) adding an adsorbent to the gaseous medium formed in step (d) and (f) removing acid gases and particulates from the gaseous medium formed in step (e). These and other features, aspects, and advantages of the present invention will become better understood with reference to the following description and appended claims.

### DESCRIPTION

The invention relates to a method that reduces dioxin levels from a process that produces dioxins, such as a thermal disposal process. The method comprises (a) adding sulfur, or another halogenation suppressant, or mixtures thereof to a composition containing dioxin precursors, (b) incinerating the composition that contains dioxin precursors, thereby forming a gaseous medium, (c) reducing heat in the gaseous medium formed in step (b), (d) removing ash from the gaseous medium, (e) adding an adsorbent to the gaseous medium formed in step (d) and (f) removing acid gases and particulates from the gaseous medium formed in step (e).

Applicants' invention is based on the surprising discovery that by practicing a specific combination of steps, the formation of dioxins ordinarily produced in disposal processes, e.g., thermal disposal processes, can be substantially reduced, and dioxin emissions can also be diminished to very low levels. Surprisingly, dioxin formation is substantially reduced when a halogenation suppressant such as sulfur is added to a composition that contains dioxin precursors. Sulfur reduces the formation of free chlorine, which in turn, reduces the formation of dioxins. Remaining dioxins that form are subsequently adsorbed by the addition of an adsorbent such as powdered activated carbon. Temperature reduction is carried out to avoid any reformation (breeding) of dioxins in a particulate control device.

Dioxin precursors can include any material that form dioxins. Examples of dioxin precursors include aromatic compounds such as phenol or benzene, chlorinated aromatic compounds such as chlorophenol or chlorobenzene, chlorinated alkyl compounds, and the like.

The composition that contains dioxin precursors can include any dioxin precursor-containing composition that can be incinerated. Preferably, the composition that contains dioxin precursors includes (i) wastewater treatment sludge, (ii) solid organic residues and (iii) a mixture of halogenated solvents.

The term “sludge” used in this application generally refers to a solid that can be separated from liquids during processing. The solid can contain a liquid, and depending on the treatment received, the sludge can be classified as primary and secondary. The source of the sludge that can be treated with the invention includes but is not limited to plants that produce chemicals, soil, rain water, sewers, spills from manufacturing machinery, lubricants of machine parts, process streams and sewage.

The contents of the sludge vary. A sludge that is obtained at a plant that produces chemicals, for instance, can include iron oxide, isocyanates, monomer resins, polyurethanes, polyols, HCl, coatings, sanitary sewage, or storm water. A sewage sludge, depending upon composition and treatment of the waste water, can contain varying amounts of organic materials of that consists mainly of a biomass of bacterial origin and varying amounts of inorganic ingredients. Sludge can also contain large amounts of water, wood fibers, calcium carbonate, calcium hydroxide, calcium chloride, other minerals and clays, various mixing catalysts (typically soy protein or casein), and chlorine-based purifying agents used in manufacturing processes. There is no precise composition for such a sludge because there are substantial variations in the feedstocks used, in the processing materials which must be used to make different types of products, and even considerable variation in the processes used by different manufacturers Chlorinated solvents include but are not limited to monochlorobenzene, dichlorobenzene, dichloromethane, 1,1-dichloroethane and methylene chloride.

The solid organic compounds include but are not limited to by-products that are obtained during the production of chemicals.

The halogenation suppressant is a material, which when added to a composition that contains dioxin precursors, suppresses formation of free halogen radicals that would ordinarily react to form dioxins and thereby inhibits the formation of dioxins. The halogenation suppressant can be added directly into a vessel that holds the composition that contains dioxin precursors. Alternatively, the halogenation suppressant can be added directly into a furnace in which the composition containing the dioxin precursors is also added. Sulfur is a preferred halogenation suppressant. Sulfur can be used in any suitable form, which when used in accordance with the invention, suppresses formation of free halogen radicals that would ordinarily react to form dioxins. Sulfur is preferably added in the form of sulfur granules. In one embodiment, sulfur is added continuously to the composition that contains dioxin precursors.

The rate at which the halogenation suppressant is added to the composition containing dioxin precursors is sufficient to reduce dioxins to a desired level. In one embodiment, the halogenation suppressant is added at a rate that is at least about 0.22 lb/hr (0.1 kg/hr) per about 9000 ft³/min (about 255 m³/min) of gaseous medium that forms during incineration. In one embodiment, the rate is about 2 to 9 kg/hour, per about 255 m³/min of gaseous medium that forms during incineration. In another embodiment, the rate ranges from about 9 kg/hour to about 20 kg, per about 255 m³/min of gaseous medium that forms during incineration. Of course, the above-mentioned rates can be expressed in terms of a desired unit volume. For instance, expressed on a per unit volume of 100 m³, a rate of about 0.1 kg/hr (of halogenation suppressant/hr) per about 255 m³/min (of gaseous medium/min) converts to about 0.0007 kg/100 m³. A rate of about 2 kg/hr of halogenation suppressant per about 255 m³/min of gaseous medium converts to about 0.01 kg/100 m³, a rate of about 9 kg/hr per about 255 m³/min converts to about 0.06 kg/100 m³, and a rate of about 20 kg/hr per about 255 m³/min converts to about 0.13 kg/100 m³. Other rates can be determined by routine experimentation, depending on the application.

The incinerator is capable of incinerating the composition containing dioxin precursors and forming a gaseous medium, which can include gases, particulates, and even liquid droplets. The type of incinerator that can be used is not critical as long as it is capable of incinerating the composition containing dioxin precursors and the added sulfur to form sulfur dioxide. Incinerators used at disposal processes are well known in the art. For instance, in one embodiment, the incinerator is a fluidized bed incinerator that includes a main chamber and a fluidized bed. The fluidized bed incinerator is dimensioned such that combustion and fluidizing air is introduced through the bottom of its main chamber, preferably through tuyeres, thereby keeping the bed fluidized.

Generally, the temperature at which the composition that contains dioxin precursors is incinerated is above the combustion temperature of the dioxin precursor-containing composition. Preferably, the temperature is at least about 800° C., and more preferably from about 800° C. to about 1200° C.

The reduction of heat in the gaseous medium that forms as a result of the incineration of the composition that contains dioxin precursors can be accomplished with any suitable technique that reduces heat in the desired application. For example, heat can be reduced by injecting water into a gaseous medium. Generally, the temperature of the gaseous medium is reduced from the incineration temperature to a temperature that is below about 200° C. As such, the temperature can be reduced from a temperature that is more than about 8000° C. to a temperature that is more than 0° C. and that is less than about 200° C.

In one embodiment, hot gases from a fluidized bed incinerator pass through a boiler for heat recovery and subsequent steam production. In this situation, water is injected after the boiler, preferably in the form of mist/fog, into the gas stream at the electrostatic precipitator entrance. Preferably, the water spray system consists of an air line, a water line, and a high flow air atomizing nozzle. Hot gases from the fluidized bed incinerator pass through a boiler where the heat is recovered to produce steam. The gases come out of the boiler at various temperatures, e.g., at about 215° C.

Any method or device capable of removing ash from the gaseous medium can be used. Suitable methods, for instance, include but are not limited to methods that utilize gravity. Suitable devices include but are not limited to baghouses and electrostatic precipitators, e.g., wet electrostatic precipitators and dry electrostatic precipitators. Electrostatic precipitators generally have two electric fields that are arranged in the direction of gas flow. Each field has its own emitting and collecting system. The two fields are separately cleaned by a rapping system. Preferably, ash is removed by use of a dry electrostatic precipitator. The volume of the electrostatic precipitator generally will vary, depending on the application. In one embodiment, ash is precipitated at a temperature that ranges from about 170° C. to about 200° C.

The adsorbent added to the gaseous medium can be any adsorbent, which when used in accordance to the invention, acomplishes objects of the invention such that dioxins are adsorbed and removed from the gaseous medium. Examples of adsorbents include titania, alumina, silica, ferric oxide, stannic oxide, magnesium oxide, kaolin, carbon, calcium sulfate, calcium hydroxide, and the like. Preferably, powdered activated carbon is added to the gaseous medium before or after ash has been removed.

The invention preferably contains a powdered activated carbon system that generally includes (i) a storage silo, (ii) a metering device and (iii) a pneumatic conveying system. The powdered activated carbon is generally added to the gaseous medium that forms after ash precipitates from the gaseous medium. In one embodiment, the powdered activated carbon is injected directly and continuously into the gaseous medium (gas stream) at a rate that is sufficient to adsorb dioxins by a desired amount.

The rate at which the powdered activated carbon is added to the gaseous medium is sufficient to reduce dioxins to a desired level. In one embodiment, the dioxin adsorbent is added at a rate that is at least about 0.22 lb/hr (0.1 kg/hr) per about 9000 ft³/min (about 255 m³/min) of gaseous medium. In one embodiment, the rate ranges from about 2 to about 9 kg/hour, per about 255 m³/min of gaseous medium. In another embodiment, the rate ranges from about 9 kg/hour to about 20 kg, per about 255 m³/min of gaseous medium. These rates can be expressed in terms of a desired unit volume. For instance, expressed on a per unit volume of 100 m³, a rate of about 0.1 kg/hr (of adsorbent/hr) per about 255 m³/min (of gaseous medium/min) converts to about 0.0007 kg/100 m³, a rate of about 2 kg/hr per about 255 m³/min converts to about 0.01 kg/100 m³, a rate of about 9 kg/hr per about 255 m³/min converts to about 0.06 kg/100 m³, and a rate of about 20 kg/hr per about 255 m³/min converts to about 0.13 kg/100 m³. Other rates can be determined by routine experimentation, depending on the application.

Acid gases and particulates are removed from the gaseous medium that has been treated with the adsorbent by any suitable technique. Generally, this is done by using scrubbers, baghouses, and precipitators. Examples of acid gases that are removed include sulfur oxides, nitrogen oxides, and hydrochloric acid.

In use, the present invention can be practiced in a broad range of applications. For instance, a sludge can be added to a sludge feed tank and the halogenation suppressant can then added to the sludge feed tank. Sulfur can be added manually or automatically to the sludge feed tank, which preferably has a turbine and an agitator that helps mix or suspend the halogenation suppressant in the sludge. It should be noted, however, that it is not necessary to add the sulfur into the sludge. In one version of the invention, sulfur can be added directly into the incinerator along with a sludge, solid organic residues, and halogenated solvents.

Without being bound by theory, the addition of the sulfur is believed to suppress free chlorine in the way sulfur dioxide (formed by the combustion of sulfur) reacts with Cl₂ to form HCl and SO₃. This suppression of Cl₂ prevents halogenation of aromatic ring systems. It is also believed that the halogenation suppressant reduces the amount of free halogen radicals that would ordinarily react with aromatic rings, e.g., benzene rings, to form dioxins. As such, free halogen atoms ordinarily would react with cyclic organic compounds to form dioxins.

As the sludge incinerates, a gaseous medium forms. Preferably, chlorinated solvents are fed through feed lances in the bottom of a fluidized bed incinerator and wastewater treatment sludge and residue are combined in a mixing feed screw and fed into the freeboard section of the incinerator. Heat is reduced and ash precipitates from the gaseous medium. A suitable amount of powdered activated carbon is added to the gaseous medium that has had ash precipitated therein. During the process, at least some sulfur dioxide that forms becomes sulfur trioxide, which in turn becomes sulfuric acid. These acids and other acids and particulates are then removed from the gaseous medium.

The invention provides substantial advantages. One principal advantage of the invention is that polychlorinated dibenzo-p-dioxins and polychlorinated dibenzofurans emissions are substantially reduced. As such, by practicing the combination of steps in accordance to the invention, dioxins such as 2,3,7,8-tetrachlorodibenzo-p-dioxin, 2,3,7,8-tetrachlorodibenzofuran, 3,3′,4,4′,5,5′-hexachlorobiphenyl are substantially reduced.

The invention is further described in the following illustrative examples in which all parts and percentages are by weight unless otherwise indicated. cl EXAMPLES

### Example 1

In this example, a method for reducing dioxin levels from a sludge disposal process was practiced in accordance with the invention.

Step A: Treatment of the Sludge with A Free Halocen Suppressant

The sludge included process waste from a plant that produced chemicals, including but not limited to toluene diisocyanate. The sources of the sludge included process waste from iron oxide, toluene diisocyanate manufacturing units, monomer resin, MDI (mono diisocyanate), polyurethanes, polyols, HCl, coatings, sanitary sewage, and storm water. The sludge was placed in a clarifier, in which the relatively heavier particles settled to the bottom of the clarifier.

The sludge was added to a 2000-gallon sludge feed tank. The sludge was stirred with a 2 horsepower (HP), 33″ (approx. 84 cm) turbine, and a 1150-rpm agitator, which helped mix and suspend the sulfur in the sludge. The agitator was manufactured by Chemineer. Sulfur granules were added manually and continuously to the sludge feed tank at approximately 15 lb/hr (approx. 6.8 kg/hr).

Step B: Incineration of the Sludge:

The composition that contained dioxin precursors that was selected for incineration was an input stream consisted of three different types of wastes, namely (i) wastewater treatment sludge from a clarifier (approximately 3500-4000 lb/hr or 1575-1800 kg/hr), (ii) solid organic residues (approximately 2000 lb/hr or approx. 900 kg/hr) and (iii) a mixture of chlorinated solvents (approximately 300-400 lb/hr or 135-180 kg/hr), in which the chlorine (Cl) permit limit was 125 lb/hr (about 57 kg/hr). The chlorinated solvents were fed through feed lances in the bottom of a fluidized bed incinerator, and the wastewater treatment sludge and residue were combined in a mixing feed screw and fed into the freeboard section of a fluidized bed incinerator.

All feeds entered the fluidized bed incinerator for thermal treatment. The fluidized bed incinerator (designed by Thyssen Engineering GMBH) was a refractory lined vessel with 62 ft² (approx. 5.6 m²) of surface area and 2000 ft³ (about 56.6 m³ of volume). Combustion and fluidizing air was intro-duced through the bottom of the main chamber through tuyeres, which kept the contents of the bed fluidized. The temperature of the bed was approximately 800-900° C., and the temperature of the free board was approximately 900-1000 ° C. during operation. The residence time of the flue gas in the fluidized bed incinerator was approximately 2 seconds. The fluidized bed incinerator used natural gas and diesel as auxiliary fuel sources, but each was gradually taken out while waste feeds were introduced. The sludge/residue mixture was incinerated and the resulting off-gases required further treatment before exiting to the atmosphere.

Step C: Reduction of Heat in the Gaseous Medium Formed

The hot gases from the fluidized bed incinerator passed through a boiler for heat recovery and subsequent steam production. The gases exited the boiler at approximately 215° C. Water was injected (in the form of mist/fog) into the gas stream at the electrostatic precipitator entrance. The water spray system consisted of an air line, water line and a high flow air atomizing nozzle.

Step D: Precipitation of Ash from the Gaseous Medium

After contacting the water spray, the gases then entered the dry particulate precipitation device (an electrostatic precipitator) at a temperature that ranged from approximately 170° C.-200° C. for ash removal. The electrostatic precipitator, manufactured by Deutsche Babcock Anlagen Aktiengesellschaft had two electric fields that were arranged in the direction of gas flow. Each field had its own emitting and collecting system. The two fields were separately cleaned by a rapping system. The electrostatic precipitator had a volume of 4120 ft³ (approx. 117 m³) 8370 ft2 (approx. 753 m²) of area and a cross-sectional area of 175 ft² (approx. 15.8 m²).

Step E: Addition of Powdered Activated Carbon to the Gaseous Medium

At the exit of the electrostatic precipitator, approximately 5-20 lb/hr (2.3-9.0 kg/hour) of powdered activated carbon was injected directly into the gas stream. The powdered activated carbon system consisted of a storage silo, a metering device and a pneumatic conveying system. The powdered activated carbon adsorbed part of the remaining polychlorinated dibenzo-dioxins and polychlorinated dibenzofuran in the flue gas after the electrostatic precipitator.

Step F: Removal of Acid Gases and Particulates From the Gaseous Medium

The off-gas, which contained powdered activated carbon, then passed through an induced draft fan (ID fan) and into the first stage of a two-stage wet scrubbing system. Acid gases and particulates were removed and the cleaned gas was discharged directly into the atmosphere via a stack.

The chlorine feeds were set to maximum, the freeboard temperature was set to minimum (approx. 904° C.-930° C.), the electrostatic precipitator inlet temperature was set by water spraying to approximately 200° C. With these settings, the average value of dioxin Toxic Equivalent (TEQ) (ng/m³ at 7% O₂) of three samples was determined to be 0.18.

### Example 2

The procedure of Example 1 was repeated except that the following conditions were used. The electrostatic precipitator inlet temperature was set to approximately 180° C. With these settings, the average TEQ (ng/m³ at 7% O₂) value of three samples of dioxin was determined to be 0.22.

### Example 3

The procedure of Example 1 was repeated except that the electrostatic precipitator inlet temperature was set to approximately 180° C. and the freeboard temperature was set to maximum (approx. 980° C.-1000° C.). With these settings, the average TEQ (ng/m³ at 7% O₂) value of three samples of dioxin was determined to be 0.29.

### Comparative Example A

The procedure of Example 1 was repeated except that sulfur was not added to the sludge and the electrostatic precipitator inlet temperature was set to be approximately 195° C. With these settings, the average TEQ (ng/m³ at 7% O₂) value of three samples of dioxin was determined to be 3.63.

### Comparative Example B

The procedure of Example 1 was repeated except that sulfur was not added to the sludge, the electrostatic precipitator inlet temperature was set to be approximately 170° C. and the freeboard temperature was set to maximum. With these settings, the average TEQ (ng/m³ at 7% O₂) value of three samples of dioxin was determined to be 2.94.

### Comparative Example C

The procedure of Example 1 was repeated except that powdered activated carbon was not added to the gaseous stream, the electrostatic precipitator inlet temperature was set to be approximately 175° C., and the freeboard temperature was set to maximum. With these settings, the average TEQ (ng/m³ at 7% O₂) value of three samples of dioxin was determined to be 1.42.

### Comparative Example D

The procedure of Example 1 was repeated except that sulfur was not added to the sludge, powdered activated carbon was not added to the gaseous stream, the electrostatic precipitator inlet temperature was set to approximately 170° C., and the freeboard temperature was set to maximum. With these settings, the average TEQ (ng/m³ at 7% O₂) value of three samples of dioxin was determined to be 1.20.

TABLE 1
Table 1 summarizes the results of Examples 1-3:

| | Example 1 | Example 2 | Example 3 |
|---|---|---|---|
| TEQ | 0.18 | 0.22 | 0.29 |
| Sulfur Feed | Yes | Yes | Yes |
| Free Board | Min. | Min. | Max. |
| Temperature | | | |
| ESP Inlet | Approx. 200° C. | Approx. 180° C. | Approx. 180° C. |
| Temperature | | | |
| PAC Addition | Yes | Yes | Yes |

TABLE 2
Table 2 summarizes the results of Comparative Examples A-D:

| | Comparative | Comparative | Comparative | Comparative |
|---|---|---|---|---|
| | Example A | Example B | Example C | Example D |
| TEQ | 3.63 | 2.94 | 1.42 | 1.20 |
| Sulfur Feed | No | No | Yes | No |
| PAC Addition | Yes | Yes | No | No |
| Free Board | Min. | Max. | Max. | Max. |
| Temperature | | | | |
| ESP Inlet | Approx. | Approx. | Approx. | Approx. |
| Temperature | 195° C. | 170° C. | 175° C. | 170° C. |

TEQ: Toxic Equivalent (ng/m³ at 7% O₂)

ESP: Electrostatic Precipitator

PAC: Powdered Activated Carbon

Freeboard Temperature:

Min: approximately 904° C.-930° C.

Max: approximately 980° C.-1000° C.

The low levels of dioxins obtained with the method of the present invention were unexpected and unanticipated. These low levels met the recently promulgated government regulatory standard, Maximum Achievable Control Technology (MACT), of 0.4 TEQ for existing incinerators using dry particulate removal devices.

Although the present invention has been described in detail with reference to certain preferred versions thereof, other variations are possible. Therefore, the spirit and scope of the appended claims should not be limited to the description of the versions contained therein.

What is claimed is:

1. A method comprising:
(a) adding sulfur, or another halogenation suppressant, or mixtures thereof to a composition containing dioxin precursors,
(b) incinerating the composition containing dioxin precursors, thereby forming a gaseous medium,
(c) reducing heat in the gaseous medium formed in step (b),
(d) removing ash from the gaseous medium,
(e) adding an adsorbent to the gaseous medium formed in step, (d), and
(f) removing acid gases and particulates from the gaseous medium formed in step (e).

2. The method of claim 1, wherein the dioxin precursors are aromatic compounds selected from the group consisting of phenols, benzene, and chlorinated aromatic compounds.

3. The method of claim 1, wherein the composition containing dioxin precursors comprises a sludge.

4. The method of claim 1, wherein the composition containing dioxin precursors comprises (i) a wastewater treatment sludge (ii) solid organic residues and (iii) a mixture of chlorinated solvents.

5. The method of claim 1, wherein the adsorbent comprises powdered activated carbon.

6. The method of claim 1, wherein the composition containing dioxin precursors is incinerated at a temperature that is at least about 800° C.

7. The method of claim 1, wherein the composition containing dioxin precursors is incinerated in a fluidized bed incinerator.

8. The method of claim 1, wherein the gaseous medium is selected from the group consisting of gases, particulates, and liquid droplets.

9. The method of claim 1, wherein the gaseous medium formed in step (b) is reduced to a temperature that is more than 0° C. and below about 200° C.

10. The method of claim 1, wherein the gaseous medium formed in step (b) is reduced to a temperature that is more than 0° C. by adding water to the gaseous medium.

11. The method of claim 1, wherein ash is removed from the gaseous medium with a precipitator.

12. The method of claim 1, wherein the sulfur, or another halogenation suppressant, or mixtures thereof is added at a rate that is at least about 0.01 kg, per 100 m³ gaseous medium, and the powdered activated carbon is added at a rate that is at least about 0.01kg, per 100 m³ gaseous medium.

13. The method of claim 1, wherein the chlorinated solvents are selected from the group consisting of dichloromethane, monochlorobenzene, dichlorobenzene, 1,1-dichloroethane and methylene chloride.

14. The method of claim 1, wherein the reduction of heat in step (b) comprises passing hot gasses from a fluidized bed incinerator through a boiler for heat recovery.

15. A method comprising:
(a) adding sulfur, or another halogenation suppressant, or mixtures thereof to a composition containing dioxin precursors that comprises (i) a wastewater treatment sludge (ii) solid organic residues and (iii) a mixture of halogenated solvents,
(b) incinerating the composition containing dioxin precursors at a temperature that is at least about 800° C., thereby forming a gaseous medium,
(c) reducing heat in the gaseous medium formed in step (b) to a temperature that is below about 200° C.,
(d) removing ash from the gaseous medium,
(e) adding activated powder to the gaseous medium formed in step (d) at a rate that is at least about 0.0007 kg, per about 100 m³ of gaseous medium,
(f) removing acid gases and particulates from the gaseous medium formed in step (e).

16. The method of claim 15, wherein the dioxin precursors are aromatic compounds selected from the group consisting of phenols, benzene, and chlorinated aromatic compounds.

17. The method of claim 15, wherein the composition containing dioxin precursors incinerates in a fluidized bed incinerator.

18. The method of claim 15, wherein the gaseous medium is selected from the group consisting of gases, particulates, and liquid droplets.

19. The method of claim 15, wherein the gaseous medium formed in step (b) is reduced to a temperature that is more than 0° C. by adding water to the gaseous medium.

20. The method of claim 15, wherein the reduction of heat in step (b) comprises passing hot gasses from a fluidized bed incinerator through a boiler for heat recovery.
